(19) United States
(12) Patent Application Publication
(10) Pub. No.: US 2026/0008882 A1
(43) Pub. Date: Jan. 8, 2026

(54) SILANE-TERMINATED POLYMERS

(71) Applicant: MERZ + BENTELI AG, Niederwangen (CH)

(72) Inventors: Stefan HUBER, Langenthal (CH); Fritz BURKHARDT, Oberburg (CH); Claude LERF, Meyriez (CH); Thomas ZUBER, Rubigen (CH)

(73) Assignee: MERZ + BENTELI AG, Niederwangen (CH)

(21) Appl. No.: 18/992,326

(22) PCT Filed: Jul. 10, 2023
(86) PCT No.: PCT/EP2023/068966

§ 371 Date: Jan. 8, 2025

(30) Foreign Application Priority Data
Jul. 11, 2022 (EP) 22184200.8

(51) Int. Cl. C08G 18/22; C08G 18/48; C08G 18/77

(52) U.S. Cl. CPC C08G 18/227; C08G 18/4825; C08G 18/778

(57) ABSTRACT

A process for producing a silane-terminated polymer in the presence of a catalyst mixture, wherein the catalyst mixture contains a bismuth and a cobalt catalyst, and the content of the cobalt catalyst is at least 2 ppm relative to the hydroxy-terminated organic polymer of the formula.

The present invention relates to a process for preparing silane-terminated polymers which can be used in sealants, adhesives and coating materials and which are storage-stable for a long period of time.

The silane-terminated polymers are prepared by known methods. A known process comprises, for example, the reaction of polyols, in particular hydroxyl-terminated polyethers, polyurethanes or polyesters, and also hydroxyl-functional polyacrylates, with (isocyanatoalkyl) alkoxysilanes.

Another method envisages a reaction of the aforementioned polyols with di-or polyisocyanates, using the latter in excess, so that isocyanate-functional polymers are produced in this first reaction step and are then reacted in a second reaction step with alkoxysilanes having an alkyl-bonded isocyanate-reactive group.

The reaction of hydroxyl-functional polymers with isocyanates is carried out in the presence of additional catalysts, since only in this way is it possible to achieve sufficiently high reaction rates for economic production of the alkoxysilane- terminated polymers in the relevant reaction step.

The use of bismuth catalysts, as described, for example, in EP1535940, leads to catalytic activity and thus to acceleration of the reaction of isocyanatosilanes with the hydroxyl-terminated polyol. But even with relatively large amounts of catalyst, long reaction times are required to achieve complete conversion. Moreover, large amounts of catalyst are likely to lead to unwanted side reactions in the synthesis and reduce the storage stability of the end products.

US 9 932 437 B2 and US 8 809 479 B2 disclose a moisture-curable resin composition having a low content of volatile organic substances. This is obtained by the reaction of a moisture-curable polymer having a hydrolyzable silyl group and a reactive modifying agent.

It is an object of the present invention to provide a process for preparing a silane-terminated polymer that permits rapid but complete conversion.

The object is achieved by the process of the invention. Preferred embodiments are the subject matter of the dependent claims.

It has been found that, surprisingly, it is possible by the process of the invention to prepare a silane-terminated polymer of the formula (I) or formula (VI)

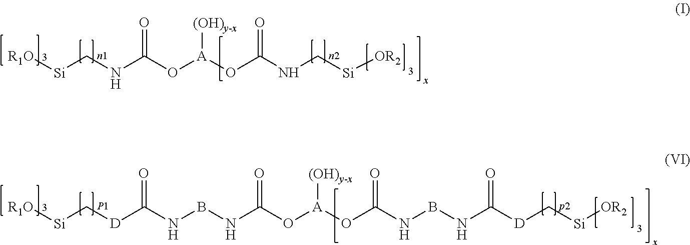

in a very efficient manner. The catalyst mixture of the invention leads to significant shortening of the reaction time. The catalyst mixture of the invention is much more effective than pure bismuth catalysts or catalyst mixtures comprising bismuth catalysts and zinc catalysts. This can firstly increase efficiency, and energy consumption is secondly lowered significantly, which is of high relevance from an economic and environmental point of view. Interestingly, however, the cobalt catalyst in the catalyst mixture cannot be replaced by a zinc catalyst since this is incapable of sufficient acceleration of the reaction.

According to the invention, the silane-terminated polymer of the formula (I) is prepared by reacting a hydroxy-terminated organic polymer of the formula (II)

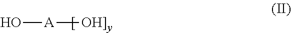

with at least one isocyanate of the general formula (III)

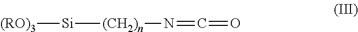

or

with a polyfunctional isocyanate of the formula (IV)

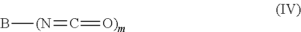

and subsequent reaction with an alkoxysilane of the formula (V)

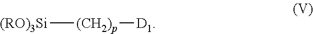

The reaction is effected in the presence of a catalyst mixture which is elucidated hereinafter. In the compounds of general formula I,

A is a polyether backbone,
x and y are natural numbers from 1 to 10, where y must be greater than or equal to x,
n, n₁ and n₂ are 1 or 3,
p, P₁ and p₂ are a natural number from 1 to 5,
m is a natural number from 2 to 10,
R, R₁ and R₂ are methyl or ethyl,
B is a linear, branched or cyclic organic radical which does not contain any isocyanate-reactive groups, and m is greater than 1,
D is selected from the group consisting of NH, NR₃ and S,
D₁ is a reactive group which reacts with the isocyanate group and is selected from the group consisting of NH₂, NHR₃ and SH, and
R₃ is a linear, branched or cyclic hydrocarbon radical having 1 to 10 carbon atoms, which may optionally comprise one or more heteroatoms selected from the group consisting of oxygen, sulfur and nitrogen.

In the process of the invention, it is possible to use one or two different isocyanates of the general formula (III). If just one isocyanate is used, R₁ and R₂ in the silane-terminated polymer of the formula (I) or of the formula (VI) are identical and correspond to R in the general formula (III). If two different isocyanates of the general formula (III) are used, R₁ corresponds to the R radical in the first isocyanate of the general formula (III) and R₂ corresponds to the R radical in the second isocyanate of the general formula (III). The same applies to n and p.

In one embodiment of the present invention, R₁ and R₂, and n₁ and n₂ , are the same. Such polymers can be obtained in a very simple manner by using just one isocyanate of the general formula (III) in the synthesis.

In a further embodiment, R₁ and R₂ or n₁ and n₂ or R₁, R₂, n₁ and n₂ are different than one another. Such polymers are obtained by means of mixtures of different isocyanates of the general formula (III). By means of this mixture, the reactivity of silane-terminated polymers can be controlled. Pure trimethoxysilane-terminated polymers crosslink quickly; pure triethoxysilane-terminated polymers react slowly. By virtue of different mixing ratios, it is possible individually adjust the reactivity correspondingly.

The catalyst mixture contains a bismuth catalyst and a cobalt catalyst, where the content of the cobalt catalyst is at least 2 ppm based on the hydroxy-terminated organic polymer of the formula (II).

In the context of the present invention, the catalyst content is reported in ppm. The figures are based on the metal that is present in the catalyst, i.e. mg of the metal per kg of the hydroxy-terminated organic polymer. The anions of the catalyst are not included in the determination of the content.

Complete conversion within the present invention means that at least 95% by weight, preferably 98% by weight, of the OH groups of the polymer backbone have reacted with the isocyanate of the general formula III or IV.

In one embodiment, the catalyst mixture does not contain any further catalyst, meaning that it consists of a bismuth catalyst and a cobalt catalyst.

The content of the bismuth catalyst in the catalyst mixture is preferably at least 10 ppm, based on the hydroxy-terminated organic polymer of the formula (II). It has been shown that a combination containing at least 2 ppm of the cobalt catalyst and at least 10 ppm of the bismuth catalyst led to very short reaction times. The reaction time is preferably shortened by 50%, more preferably by 65%. The silane-terminated polymer can be prepared continuously or batchwise.

In one embodiment, the silane-terminated polymer relates to a linear polymer of the general formula IA

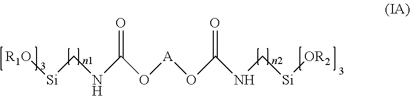

where R₁, R₂, n₁, n₂ and A have the same definition as above. R₁ and R₂, and n₁ and n₂, are identical when only one isocyanate of the general formula (III) is used. If two different isocyanates of the general formula (III) are used, R₁ and R₂ or n₁ and n₂ or R₁, R₂, n₁ and n₂ are different than one another, with formation of a random distribution of polymers R₁—A—R₁, R₁—A—R₂ and R₂—A—R₂. A preferred embodiment relates to the linear polymer of the general formula IB

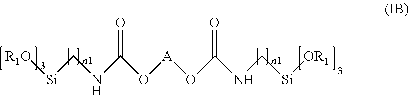

which is prepared using only one isocyanate of the general formula (III).

Linear silane-terminated polymers of the formula (IB) are more preferably used for sealants and coating materials that require greater for example elasticity, for joining compounds, elastic adhesives, surface sealants, or in the marine sector, for example for grouting of teak. After curing, such linear polymers become softer and more elastic; the branched polymers described hereinafter become harder and less elastic owing to the higher crosslinking density.

In a second embodiment, the silane-terminated polymer relates to a branched polymer of the general formula IC

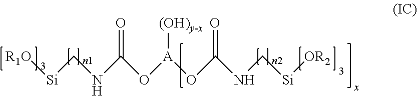

where R₁, R₂, n₁ and n₂ and A have the same definition as above, and x and y are natural numbers from 2 to 10. The content of isocyanate of the formula III may be varied based on the OH groups. Depending on the desired number of free OH groups, preferably 90 mol % to 130 mol % of isocyanate of the formula III is used. Preferably, the silane-terminated polymer of the formula IC is substantially free of free OH groups, i.e. y and x are essentially identical and the difference of y−x is accordingly about 0. Branched silane-terminated polymers of the formula IC are used with particular preference for adhesives, sealants and coating compositions that require a higher Shore A hardness and a higher crosslinking density, as for example in the case of high-modulus adhesives, surface sealants, or floor coatings. The catalyst mixture of the invention has no adverse effect on the storage stability of the adhesives, sealants and coating compositions produced therefrom, and therefore need not be removed from the polymer in a complex manner. In order to prevent discoloration after prolonged storage time, it is optionally possible to add a deactivator or a complexing agent.

The hydroxy-terminated organic polymer of the formula

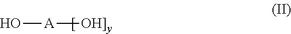

preferably has a polyether backbone A containing repeat alkylene oxide units having 2 to 6 carbon atoms, preferably 2 or 3 carbon atoms, i.e. propylene oxide and ethylene oxide, or combinations thereof. The hydroxy-terminated organic polymer may be a homopolymer or a copolymer composed of different polyether units.

The expression “copolymers thereof” means polymers composed of two or more monomer units. In addition to alternating copolymers and graft copolymers, the term also includes, in particular, block polymers which consist of longer sequences or blocks of each monomer and can be linked to one another via linker compounds. Such copolymers may contain, for example, aromatic glycol chain extenders having a total number of carbon atoms of 6 to 16 and preferably 6 to 12. Examples of suitable glycol chain extenders are benzene glycol and xylene glycols, which are a mixture of 1,4-di (hydroxymethyl) benzene and 1,2-di (hydroxymethyl) benzene. Benzene glycol is preferred and especially comprises hydroquinone, i.e. the bis (beta-hydroxyethyl) ether, which is also known as 1,4-di (2-hydroxyethoxy) benzene, resorcinol, i.e. the bis (beta-hydroxyethyl) ether, which is also known as 1, 3-di (2-hydroxyethyl) benzene, catechol, i.e. the bis (beta-hydroxyethyl) ether, which is also known as 1,2-di (2-hydroxyethyl) benzene, and combinations thereof.

The expression “hydroxy-terminated” means polymers bearing free hydroxyl groups at the end of the molecule. y is a natural number from 1 to 10. In a preferred embodiment, y=1 and then corresponds to an α, ω-dihydroxy-terminated organic polymer, i.e. a polymer having two terminal OH groups. If y is greater than 1, the hydroxy-terminated polyol has more than two terminal OH groups, i.e. it is a polyol wherein the OH groups are intended to react with the isocyanate of the formula III. In the case of branched hydroxy-terminated polymers, the OH groups are preferably not attached directly to the polymer backbone, but rather to the end of side chains of the polymer backbone. They can be obtained, for example, by reactions with polyols. Both linear and branched hydroxy-terminated organic polymers are known to those skilled in the art and are also commercially available.

Examples of possible hydroxy-terminated polymers having a polyether polymer backbone are Acclaim® 4200, Acclaim® 6300, Acclaim® 8200, Acclaim® 1 18200 (or the corresponding Acclaim® xx00N product) from Covestro AG, PREMINOL S 1004F, PREMINOL S 4013F, PREMINOL S 4318F, PREMINOL S 3011, PREMINOL 5001F, PREMINOL 7001K, PREMINOL 7012 from AGC, Rokopol LDB Delta 12000, Rokopol LDB 18000D, Rokopol LDB 12000D, ROKAmer PPG 4000, Rokopol LDB8000D from PCC Group, Voranol 3008, Voranol 3010, Voranol 3022J, Voranol 3136, Voranol 4000 LM, Voranol 4053, Voranol 8000 LM from DOW.

Preferably, the hydroxy-terminated organic polymer is liquid at room temperature. This means a viscosity at 20° C. of 1 to 10⁶ mPa*s. This viscosity is optimal for handling of the composition of the invention, especially in the production of sealant preparations.

The hydroxy-terminated organic polymer preferably has an average molecular weight of 1000-50 000 g/mol, in particular 2000-25 000 g/mol, since the handling of said polymers is optimal, optionally with addition of a plasticizer to improve processibility. Suitable plasticizers are known to the person skilled in the art. Preferred plasticizers are, for example, phenyl alkanesulfonates such as Mesamoll from Lanxess, cyclohexanoate plasticizers such as Elatur DINCD from Evonik, diisononyl 1, 2-cyclohexanedicarboxylates such as Hexamoll DINCH from BASF, hydrocarbons, for example Shellsol D100 from Shell, and diesters of dicarboxylic acids such as dioctyl sebacate, dioctyl adipate or dioctyl azelate. In the present document, “molecular weight” means the molar mass (in grams per mole) of a molecule. “Average molecular weight” refers to the number-average molecular weight Mn of a polydisperse mixture of oligomeric or polymeric molecules, which is usually determined by titrating the acid number and OH number. It can alternatively also be determined by analytical methods such as GPC/MALDI. OH number (hydroxyl number) is a measure of the hydroxyl group content in polymers and is a quantity known to those skilled in the art. Acid number is a measure of the content of acid groups in polymers and is a quantity known to those skilled in the art.

The hydroxy-terminated organic polymers of the formula (II) that are used in accordance with the invention may be commercially available compounds which, for better handling, may optionally be diluted with a plasticizer or solvent.

In a preferred embodiment of the present invention, the reaction is effected with an isocyanate selected from the group consisting of 3-isocyanatopropyltrimethoxysilane and 3-isocyanatopropyltriethoxysilane or mixtures thereof. As shown in the examples that follow, these two silanes can be converted very effectively with the catalyst mixture of the present invention. the case In of isocyanatopropyltriethoxysilane, which is the less reactive, the cobalt catalyst content is preferably more than 4 ppm, more preferably more than 5 ppm, in order to obtain a very fast reaction.

The cobalt catalyst is preferably selected from the group consisting of cobalt (II) hexafluoroacetylacetonate, cobalt (II) benzoate, cobalt (II) isopropoxide, cobalt (II) acetylacetonate or cobalt (II) 2, 4-pentanedionate, cobalt (II) oxalate, cobalt (II) citrate, cobalt (II) hydroxide, cobalt (II) acetate, cobalt (II) stearate, bis (2,2, 6, 6-tetramethyl-3,5-heptanedionato) cobalt (II), cobalt (II) oleate, cobalt (II) 2-ethylhexanoate (commercially available as Octa-Soligen® Cobalt 10 from Borchers), cobalt (II) naphthenate (commercially available as 6% Cobalt Nap-All® from Borchers), cobalt (II) neodecanoate (commercially available as Borchers® Deca Cobalt 10 from Borchers) and cobalt (II) resinate, with particular preference for cobalt (II) neodecanoate.

The bismuth catalyst is preferably selected from the group consisting of bismuth (III) isopropoxide, bismuth (III) tert-pentoxide, bismuth (III) oleate, bismuth (III) 2-ethylhexanoate (commercially available as Borchi® Kat 320 from Borchers), bismuth (III) neodecanoate (commercially available as Borchi® Kat 315 from Borchers) and bismuth (III) acetylacetanoate, with particular preference for bismuth (III) neodecanoate.

The catalyst mixture is preferably added in a total amount of 8 to 500 ppm, more preferably 8 to 100 ppm and most preferably 10 to 50 ppm.

The catalysts may either be stirred to give a mixture before the reaction and added to the reaction mixture or else mixed directly in the prepolymer. The catalyst mixture is preferably freshly prepared prior to use, since the best reactivity is achieved in this way. It has also been found that the catalyst mixture has better solubility when the isocyanate is already present in the reactor on addition of the catalyst mixture.

In the case of colorless end products, a cobalt catalyst content of 2 to 5 ppm is preferred, since discoloration of the product can otherwise arise.

The linear silane-terminated polymers are particularly preferably selected from the group consisting of

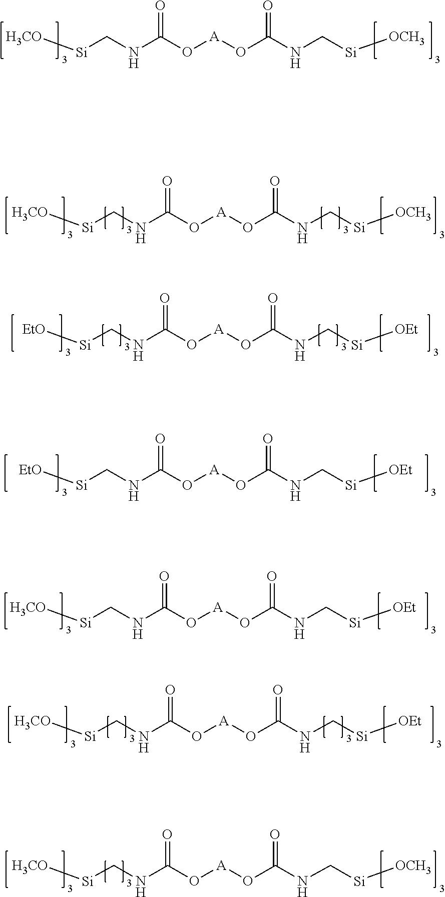

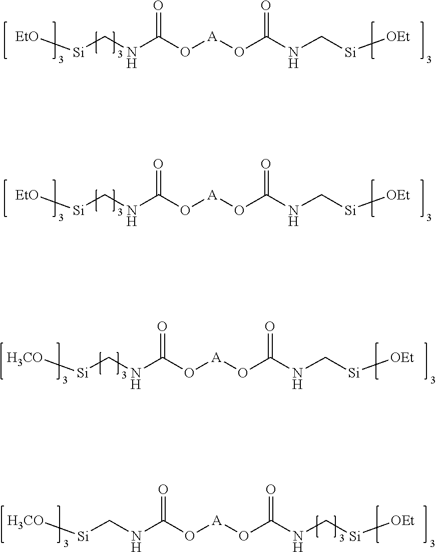

where A is a polymer backbone as defined above. It has been found that these linear silane-terminated polymers can be prepared particularly effectively by means of the catalyst mixture of the invention.

The process of the invention for preparing the silane-terminated polymer of the formula (VI) is effected by reacting a hydroxy-terminated organic polymer of the formula

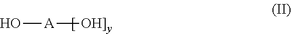

with a polyfunctional isocyanate of the formula (IV) B—(N═C═O)ₘ (IV), followed by reaction with an alkoxysilane of the formula (V)

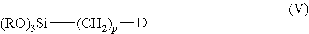

in the presence of the catalyst mixture of the invention.

Particularly suitable polyfunctional isocyanates of the formula (IV) are isocyanates having two or more, preferably 2 to 10, isocyanate groups in the molecule. Suitable for this purpose are the known aliphatic, cycloaliphatic, aromatic, oligomeric and polymeric polyfunctional isocyanates which do not contain any isocyanate-reactive groups, i.e. in particular do not have any free primary and/or secondary amino groups. A representative of the aliphatic polyfunctional isocyanates is, for example, hexamethylene diisocyanate (HDI); a representative of the cycloaliphatic polyfunctional isocyanates is, for example, 1-isocyanato-3-(isocyanatomethyl)-3, 5, 5-trimethylcyclohexane (IPDI). Representatives of the aromatic polyfunctional isocyanates include: 2,4-and 2, 6-diisocyanatotoluene and the corresponding technical isomer mixture (TDI); diphenylmethane diisocyanates, such as diphenylmethane 4,4′-diisocyanate, diphenylmethane 2, 4′-diisocyanate, diphenylmethane 2,2′-diisocyanate and the corresponding technical isomer mixtures (MDI). In addition, mention should also be made of naphthalene-1, 5-diisocyanate (NDI) and 4,4′,4″-triisocyanatotriphenylmethane. The reaction is preferably carried out at temperatures between 50° C. and 150° C., more preferably at 60° C. to 120° C., and preferably at standard pressure.

The crosslinkable compositions prepared in accordance with the invention are of excellent suitability as sealing compounds for joints, including vertical joints, and similar empty spaces, for example in buildings, land vehicles, watercraft and aircraft, or as adhesives, especially for bonding of substrates having different coefficients of thermal expansion, for example in vehicle construction, facade construction or solar applications, or cementing compounds, for example in window construction or in the production of showcases, and also for production of protective coatings or rubber-elastic moldings and for insulation of electrical or electronic devices. The compositions of the invention are particularly suitable as sealing compounds for joints with possible high movement tolerance.

The usual water content of the air is sufficient for the crosslinking of the composition of the invention. The crosslinking may be carried out at room temperature or, if desired, even at higher or lower temperatures, for example at -5° C. to 10° C. or at 30° C. to 50° C. The crosslinking is preferably carried out at standard pressure.

The silane-terminated polymers of the invention may also be formulated as a 2-component system. In addition to auxiliaries, the second component also comprises water, which greatly accelerates deep through-curing after mixing with the first component. Corresponding 2-component systems are known to those skilled in the art and are described, for example, in EP2009063 or EP2535376, the content of which is incorporated by reference.

The preparations of the invention may contain further auxiliaries and additives. These auxiliaries and additives include, for example, further silane-terminated polymers, plasticizers, stabilizers, antioxidants, fillers, reactive diluents, desiccants, adhesion promoters and UV stabilizers, rheological aids, color pigments or color pastes, catalysts for crosslinking and/or possibly also solvents to a small extent. Such auxiliaries and additives are known to those skilled in the art.

### EXAMPLES

### Comparative Examples 1 to 10 and Inventive Examples 11-20

230 g (11.65 mmol, determined via titration of OH number) of Acclaim Polyol 18200N is introduced into a reaction flask and predried at 80° C. and 1 mbar for 30 min. The vacuum is broken with nitrogen. Within 2 minutes, at a stirrer speed of 170 rpm, 5.09 g (23.3 mmol) of 94% -isocyanatopropyltrimethoxysilane is slowly added dropwise. 2 minutes after completion of addition of the isocyanatopropyltrimethoxysilane, the catalyst mixture (see table) dissolved in diisononyl phthalate is added to the reaction mixture. The progress of the reaction was determined by FTIR from the increase in absorption at 1722 cm−1 (C═O) absorption of the product) and the decrease in absorption at 2270 cm−1 (NCO absorption of the reactant).

TMS-NCO: 3-isocyanatopropyltrimethoxysilane

| | | | | Reaction progress | Reaction progress | NCO |
|---|---|---|---|---|---|---|
| Example | Bi[ppm] | Zn[ppm] | Co[ppm] | after 25 min | after 60 min | silane |
| 1 | 16.42 | — | — | incomplete | incomplete | TMS- |
| | | | | | | NCO |
| 2 | 27.01 | — | — | incomplete | incomplete | TMS- |
| | | | | | | NCO |
| 3 | 31.65 | — | — | incomplete | incomplete | TMS- |
| | | | | | | NCO |
| 4 | 42.46 | — | — | incomplete | incomplete | TMS- |
| | | | | | | NCO |
| 5 | 56.47 | — | — | incomplete | complete | TMS- |
| | | | | | | NCO |
| 6 | 24.9 | 2.6 | — | incomplete | complete | TMS- |
| | | | | | | NCO |
| 7 | — | — | 3.58 | incomplete | incomplete | TMS- |
| | | | | | | NCO |
| 8 | — | — | 5.71 | incomplete | incomplete | TMS- |
| | | | | | | NCO |
| 9 | — | — | 7.00 | incomplete | complete | TMS- |
| | | | | | | NCO |
| 10 | 6.8 | — | 1.7 | incomplete | incomplete | TMS- |
| | | | | | | NCO |
| 11 | 14.5 | — | 3.66 | complete | | TMS- |
| | | | | | | NCO |
| 12 | 15.6 | — | 3.96 | complete | | TMS- |
| | | | | | | NCO |
| 13 | 19.36 | — | 2.57 | complete | | TMS- |
| | | | | | | NCO |
| 14 | 11.02 | — | 3.38 | complete | | TMS- |
| | | | | | | NCO |
| 15 | 10.6 | — | 3.93 | complete | | TMS- |
| | | | | | | NCO |
| 16 | 10.91 | — | 4.89 | complete | | TMS- |
| | | | | | | NCO |
| 17 | 20.36 | — | 3.47 | complete | | TMS- |
| | | | | | | NCO |
| 18 | 23.89 | — | 3.86 | complete | | TMS- |
| | | | | | | NCO |
| 19 | 31.09 | — | 4.13 | complete | | TMS- |
| | | | | | | NCO |
| 20 | 19.01 | — | 5.83 | complete | | TMS- |
| | | | | | | NCO |

### Comparative Examples 21 to 26 and Inventive Examples 27-29

230 g (11.65 mmol, determined via titration of OH number) of Acclaim Polyol 18200N is introduced into a reaction flask and predried at 80° C. and 1 mbar for 30 min. The vacuum is broken with nitrogen. Within 2 min, at a stirrer speed of 170 rpm, 6.13 g (23.3 mmol) of 94% 3-isocyanatopropyltriethoxysilane is slowly added dropwise. 2 min after completion of addition of the silane, the catalyst mixture (see table) dissolved in diisononyl phthalate is added to the reaction mixture. The progress of the reaction was determined by FTIR from the increase in absorption at 1722 cm−1 (C═O absorption of the product) and the decrease in absorption at 2270 c−1 (NCO absorption of the reactant).

TES-NCO: 3-isocyanatopropyltriethoxysilane

| | | | | Reaction progress | Reaction progress | NCO |
|---|---|---|---|---|---|---|
| Example | Bi[ppm] | Zn[ppm] | Co[ppm] | after 25 min | after 60 min | silane |
| 21 | 46.85 | — | — | incomplete | incomplete | TES- |
| | | | | | | NCO |
| 22 | 65.97 | — | — | incomplete | complete | TES- |
| | | | | | | NCO |
| 23 | 70.12 | — | — | incomplete | complete | TES- |
| | | | | | | NCO |
| 24 | — | — | 4.28 | incomplete | incomplete | TES- |
| | | | | | | NCO |
| 25 | — | — | 6.51 | incomplete | complete | TES- |
| | | | | | | NCO |
| 26 | | | 8.86 | incomplete | complete | TES- |
| | | | | | | NCO |
| 27 | 13.7 | — | 5.11 | complete | | TES- |
| | | | | | | NCO |
| 28 | 12.03 | — | 4.48 | complete | | TES- |
| | | | | | | NCO |
| 29 | 40.5 | — | 4.91 | complete | | TES- |
| | | | | | | NCO |

1. A process for preparing a silane-terminated polymer of the formula (I) or (VI) 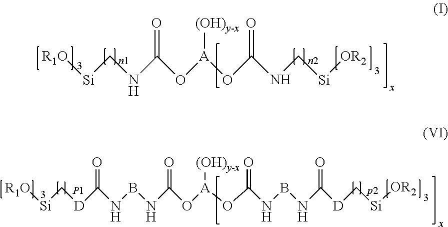
by reacting a hydroxy-terminated organic polymer of the formula (II) 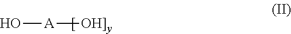
with at least one isocyanate of the general formula (III) 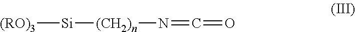
or
with a polyfunctional isocyanate of the formula (IV) 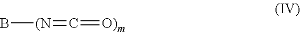
and subsequent reaction with an alkoxysilane of the formula (V) 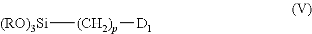
in the presence of a catalyst mixture, wherein
A is a polyether backbone,
x and y are natural numbers from 1 to 10, where y must be greater than or equal to x,
n, n₁ and n₂ are 1 or 3,
p, p₁ and p₂ are a natural number from 1 to 5,
m is a natural number from 2 to 10, and
R, R₁ and R₂ are methyl or ethyl,
B is a linear, branched or cyclic organic radical which does not contain any isocyanate-reactive groups, and m is greater than 1,
D is selected from the group consisting of NH, NR₃ and S,
D₁ is a reactive group which reacts with the isocyanate group and is selected from the group consisting of NH₂, NHR₃ and SH, and
R₃ is a linear, branched or cyclic hydrocarbyl radical which has 1 to 10 carbon atoms and may optionally comprise one or more heteroatoms selected from the group consisting of oxygen, sulfur and nitrogen,
wherein the catalyst mixture contains a bismuth catalyst and a cobalt catalyst, and where the content of the cobalt catalyst is at least 2 ppm based on the hydroxy-terminated organic polymer of the formula (II).

2. The process as claimed in claim 1, wherein the content of the bismuth catalyst is at least 10 ppm based on the hydroxy-terminated organic polymer of the formula (II).

3. The process as claimed in claim 1, wherein the silane-terminated polymer is a linear polymer of the general formula IA

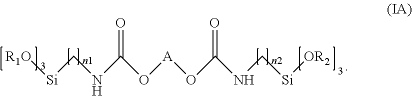

4. The process as claimed in claim 1, wherein the silane-terminated polymer is a linear polymer of the general formula IB

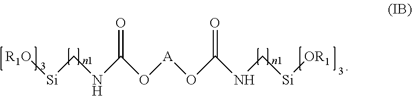

5. The process as claimed claim 3, wherein the linear silane-terminated polymers are selected from the group consisting of 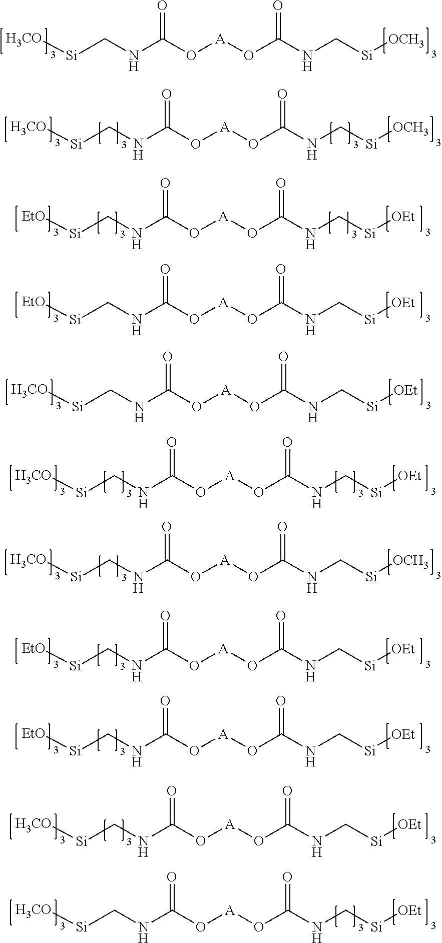
where A is a polyether backbone as defined above.

6. The process as claimed in claim 1, wherein the silane-terminated polymer is a branched polymer of the general formula (IC) 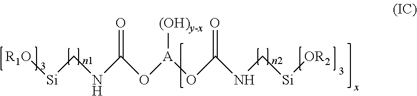
where x and y each correspond to a natural number from 2 to 10.

7. The process as claimed in claim 6, wherein the silane-terminated polymer of the formula (IC) is essentially free of free hydroxyl groups.

8. The process as claimed in claim 1, wherein the reaction is effected with an isocyanate selected from the group consisting of 3-isocyanatopropyltrimethoxysilane and 3-isocyanatopropyltriethoxysilane.

9. The process as claimed in claim 1, wherein the cobalt catalyst is selected from the group consisting of cobalt(II) hexafluoroacetylacetonate, cobalt(II) benzoate, cobalt(II) isopropoxide, cobalt(II) acetylacetonate, cobalt(II) oxalate, cobalt(II) citrate, cobalt(II) hydroxide, cobalt(II) acetate, cobalt (II) stearate, bis (2,2,6,6-tetramethyl-3,5-heptanedionato) cobalt (II), cobalt (II) oleate, cobalt (II) 2-ethylhexanoate, cobalt (II) naphthenate, cobalt (II) neodecanoate and cobalt (II) resinate.

10. The process as claimed in claim 1, wherein the bismuth catalyst is selected from the group consisting of bismuth(III) isopropoxide, bismuth(III) tert-pentoxide, bismuth(III) oleate, bismuth(III) 2-ethylhexanoate, bismuth(III) neodecanoate and bismuth(III) acetylacetanoate.

11. The process as claimed in claim 1, wherein the hydroxy-terminated organic polymer has an average molecular weight of 1000-40 000 g/mol.

12. The process as claimed in claim 1, wherein the content of the cobalt catalyst is 2 to 5 ppm, based on the hydroxy-terminated organic polymer of the formula (II).
